(19) United States
(12) Patent Application Publication
(10) Pub. No.: US 2026/0166463 A1
(43) Pub. Date: Jun. 18, 2026

(54) RING FILTER ELEMENT WITH RADIALLY INNER ENGAGEMENT CONTOUR FOR ANGULAR POSITIONING

(71) Applicant: MANN+HUMMEL GmbH, Ludwigsburg (DE)

(72) Inventors: Pascal NEEF, Trossingen (DE); Philipp HETTKAMP, Steinheim (DE); Johannes GRAD, Simbach (DE); Pedro Miguel PEREIRA MADEIRA, Bietigheim-Bissingen (DE); Eva HALLBAUER, Himmelkron (DE); Peter PEKNY, Neuenmarkt (DE); Andreas WEBER, Freiberg (DE); Christoph WITTMERS, Bietigheim-Bissingen (DE); Steffen GERLACH, Nufringen (DE); Mario RIEGER, Ludwigsburg (DE); Markus HANSELMANN, Lauffen (DE); Friedrich KUPFER, Marklkofen (DE); Dieter WEISS, Gefrees (DE); Daniel SCHMID, Sachsenheim (DE); Dennis STARK, Mauer (DE); Klaus-Dieter RUHLAND, Meckenheim (DE); Michael KAUFMANN, Meckenheim (DE)

(21) Appl. No.: 19/534,009

(22) Filed: Feb. 9, 2026

Related U.S. Application Data
(63) Continuation of application No. PCT/EP2024/079189, filed on Oct. 16, 2024.

(30) Foreign Application Priority Data
Oct. 23, 2023 (DE) 10 2023 129 022.3

(51) Int. Cl. B01D 46/52; B01D 46/00; B01D 46/24; B01D 46/64; H01M 8/0662

(52) U.S. Cl. CPC B01D 46/522; B01D 46/0005; B01D 46/2414; B01D 46/64; H01M 8/0687; B01D 2265/021; B01D 2265/06; B01D 2271/027

(57) ABSTRACT

A ring filter element for air filtration has a filter medium body enclosing an interior. An open end disc and a closed end disc delimit seal-tightly the filter medium body axially. The filter medium body has a folded bellows and an inner wall surface provided with a fold expansion. The open end disc has a cutout aligned with the fold expansion. A filter device has a filter housing with fluid inlet and fluid outlet. A ring filter element arrangement arranged in the filter housing separates fluid inlet from fluid outlet. The ring filter element arrangement has a ring filter element. A positioning device has an engagement element which extends radially outwardly and engages a counter engagement element of the ring filter element which is at least partially formed by the fold expansion at the inner wall surface of the filter medium body of the ring filter element.

### CROSS REFERENCE TO RELATED APPLICATIONS

This application is a continuation application of international application No. PCT/EP2024/079189 having an international filing date of Oct. 16, 2024, and designating the United States, the international application claiming a priority date of Oct. 23, 2023, based on prior filed German patent application No. 10 2023 129 022.3, the entire contents of the aforesaid international application and of the aforesaid German patent application being incorporated herein by reference.

### BACKGROUND

The invention concerns a ring filter element for air filtration including a filter medium body enclosing an interior, as well as an open end disc and a closed end disc which sealingly delimit the filter medium body in axial direction.

Such a ring filter element is disclosed in US 2021/0069630 A1, for example.

In air filtration, for example, for internal combustion engines or fuel cells, it is important that suitable ring filter elements are employed for the respective application. In addition, it is often important that the ring filter element is correctly aligned. For example, mass air flow sensors often react sensitively to a changed alignment of filter elements. In case of ring filter elements with substantially rotational symmetry which exhibit certain manufacture-related deviations from the rotational symmetry, this also applies when they are installed in different rotational positions.

US 2019/0308125 A1 discloses a round filter element that includes a filter medium body whose wall may be flowed through by the fluid to be purified in radial direction, wherein at or adjacent to an end face a circumferentially extending seal carrier is arranged which carries a positioning element for form-fit connection to a correlated housing-side counter positioning element. For this purpose, a cutout which is radially outwardly open is provided in an open end disc.

EP 2 535 550 A2 discloses a ring filter element, for example for a filter device of a fresh air device of an internal combustion engine, including a ring-shaped filter body of a folded web material. End folds that are adjoining each other in the circumferential direction are connected directly or indirectly to each other for forming a connection region suitable for rotational position alignment of the filter element. In the connection region, a radially outwardly open longitudinal groove may be formed which in particular can be easily felt from the exterior and, for example, enables a mandatory alignment. An end disc may include a radially outwardly open recess that is complementary to the radially outwardly open longitudinal groove. As an alternative, a radially inwardly open longitudinal groove may be provided in the connection region. The respective groove base of the longitudinal groove may be formed, for example, by end folds that are contacting each other. At a housing, an alignment contour is formed which upon insertion of the ring filter element interacts with the connection region in order to force a predetermined rotational position of the ring filter element within the housing in this way.

The already aforementioned US 2021/0069630 A1 describes a filter element with a filter bellows which extends along a longitudinal axis and encloses an interior. The filter bellows is formed of a folded filter material arranged on a support tube. The filter bellows may be designed as a round element. At an end face first end and at an opposed end face second end of the filter element, end discs are arranged which seal the filter bellows at the end face edges, wherein one end disc is open and the other one is closed. The filter bellows includes at both of its ends an external notch, respectively, whose axial length in the direction of the longitudinal axis is shorter than the length extension of the filter bellows. The notches are locally limited and do not extend across the entire length of the folded bellows. The notches have the greatest fold edge distance at the respective end discs and taper with increasing distance away from the end disc. The notches widen the distance between two neighboring folds, wherein the folds as a whole extend across the entire length of the folded bellows. The notches enable a positionally correct installation of the filter element in a housing.

In case of an external fold expansion, there is a certain danger that the filter medium body, in particular at fold edges which delimit the fold expansion, becomes damaged during handling, for example, when beating for cleaning purposes.

It is an object of the invention to protect a contour serving for alignment of a ring filter element from becoming damaged.

### SUMMARY

This object is solved by a ring filter element for air filtration, for example for filtration of the intake air of a fuel cell, including a filter medium body enclosing an interior and further includes an open end disc and a closed end disc which seal-tightly delimit the filter medium body in axial direction, wherein the filter medium body includes a folded bellows which is provided with a fold expansion at an inner wall surface and wherein the open end disc includes a cutout which is aligned with the fold expansion.

This object is solved furthermore by a filter device including a filter housing with at least a fluid inlet and a fluid outlet and further including a ring filter element arrangement which is arranged in the filter housing and separates the fluid inlet from the fluid outlet, wherein the ring filter element arrangement includes at least one first ring filter element according to the invention, wherein the filter device includes a positioning device with at least one engagement element extending in radially outward direction, wherein the fold expansion at the inner wall surface of the filter medium body of the first ring filter element at least partially forms a counter engagement element, and wherein the engagement element engages the counter engagement element.

Also, this object is solved by a use of a filter device according to the invention as cathode air filter of a fuel cell, and by a use of a ring filter element according to the invention in a filter device with a filter housing, wherein an engagement element arranged at the filter housing engages a fold expansion.

Embodiments are disclosed in the following description and accompanying drawings.

According to the invention, a ring filter element for air filtration, for example for the filtration of the intake air of a fuel cell, is provided. For a use, the ring filter element may be arranged in a filter housing. For example, the ring filter element may be employed as a cathode air filter of a fuel cell.

The ring filter element includes a filter medium body which encloses an interior. The ring filter element is therefore closed in a circumferential direction. The ring filter element may be flowed through radially from the exterior to the interior. As an alternative, a flow from the interior to the exterior in radial direction may be provided.

A longitudinal axis of the filter medium body may extend through its interior. In other words, the filter medium body may surround the longitudinal axis in a ring shape. Directional specifications like radial or axial relate to the longitudinal axis. An angular position of the ring filter element may also be determined in relation to the longitudinal axis.

Furthermore, the ring filter element includes an open end disc and a closed end disc which sealingly delimit the filter medium body in axial direction. The two end discs are arranged at opposite axial ends of the filter medium body. The open end disc may additionally seal the ring filter element in relation to the filter housing and/or a further ring filter element. The open end disc includes at least one central opening which opens the interior to the exterior at an axial end. In the mounted state, a fluid outlet or a fluid inlet may communicate through the central opening with the interior. At the other axial end, the closed end disc prevents inflow into or outflow out of the interior; bypassing of the filter medium body is thus prevented.

The end discs may be molded or glued onto the filter medium bodies. The end discs may be included, for example, of polyurethane, for example polyurethane foam.

The closed end disc may be a single piece or a multi-part configuration. A multi-part closed end disc may include, for example, a closure member which is embedded in an annular body of the end disc.

The filter medium body includes a folded bellows which, according to the invention, is provided with at least one fold expansion at an inner wall surface. The folded bellows or the filter medium body may be for example formed by a star-shaped folded filter medium. A fold angle and/or a fold distance (distance measured in circumferential direction of radially inner fold edges) may be larger in the region of the fold expansion at the inner wall surface of the ring filter element than for a plurality of folds of the fold bellows. For example, apart from the region of the at least one fold expansion, all folds may include the same fold angle or fold distance. The fold expansion at the inner wall surface adjoins, as a matter of principle, the open end disc.

The fold expansion forms, at least partially, a counter engagement element for engagement by an engagement element of a positioning device for an unequivocal relative angular positioning of the ring filter element in relation to the filter housing or to a further filter element of the filter device. The fold expansion creates a space for the engagement of the engagement element of the positioning device. In addition, the locally present fold expansion provides a defined angular position of the first ring filter element in relation to the engagement element. The engagement element and the counter engagement element may be matched relative to each other (i.e., they correspond to each other) such that a deformation of these elements during mounting is necessary only to a minimal degree or not necessary, but at the same time however only a minimal or no rotational clearance occurs. The former reduces the required force expenditure and avoids damages. The latter effects the defined rotatory alignment of the ring filter element. The rotational clearance in relation to a center position may amount to, for example, maximally +/−5°, or maximally +/−3°, or maximally +/−1°.

Further in accordance with the invention, the open end disc includes at least one cutout which is aligned with the fold expansion. When a plurality of fold expansions are provided, one cutout is aligned with one of the fold expansions, respectively. The cutout and the fold expansion overlap each other in circumferential direction and in radial direction. The cutout may be arranged at an inner circumference of the open end disc. The cutout in the end disc facilitates the insertion of the engagement element in the fold expansion. The cutout in the open end disc may also be part of the counter engagement element engaged by the engagement element in the mounted state.

Due to the inwardly positioned arrangement of the fold expansion and of the cutout, they are protected from being mechanically damaged when handling the ring filter element. For example, there is no risk that, when beating the ring filter element, fold edges which delimit the fold expansion may be deformed or even torn.

The fold expansion may extend across a portion of the height of the folded bellows. This may be advantageous in regard to the flow through the filter medium body.

As an alternative, the fold expansion may extend across the complete height of the folded bellows. This may simplify the manufacture of the ring filter element.

The filter medium body may include a hollow cylindrical shape. For example, the ring filter element or its filter medium body may be of a circular ring shape in cross section. Such a ring filter element may be produced economically and provides an excellent installation space utilization. In embodiments, the filter medium body may have an oval or elongate oval cross section. As an alternative or in addition, the filter medium body may taper along the longitudinal axis. In other words, the filter medium body may include a conical shape as a whole.

At an outer wall surface of the filter medium body, a spiral-wound string may be provided. In other words, a string may be spirally wound around the outer side of the filter medium body. In this way, the filter bellows may be additionally fixed and stabilized.

A plurality of fold expansions may be provided distributed about the inner circumference of the folded bellows, wherein the open end disc includes a plurality of cutouts, each one being aligned with one of the fold expansions, respectively. Due to the rotational symmetry arrangement of the cutouts, mounting of the ring filter element may be simplified.

It is however provided that the fold expansions and cutouts in relation to a longitudinal axis are arranged in a pattern having no rotational symmetry. Then, an unequivocal angular position of the ring filter element is created. This is advantageous in order to achieve a defined flow, for example, in regard to a measuring precision of a downstream component, for example, a mass air flow sensor. In addition, an arrangement having no rotational symmetry may effectively prevent the use of unsuitable ring filter elements when a plurality of, for example all, fold expansions are engaged by an engagement element, respectively.

The at least one cutout of the open end disc may be open radially inwardly. The cutout and a central opening of the end disc then pass directly into each other. The radially inwardly open cutout at the rim may also be referred to as a bulge of the central opening. An inwardly open cutout facilitates the insertion of an engagement element when mounting the filter element.

As an alternative, the cutout of the open end disc may be radially inwardly closed. The cutout and the central opening of the end disc are then separated from each other by the material of the end disc in radial direction. An engagement element of the type of an axial protrusion may project through the cutout closed at the rim side into the fold expansion.

It may be provided that the cutout tapers radially outwardly and/or widens radially outwardly and/or that at least one lateral edge of the cutout may have at least one kink. When an engagement element also has a corresponding contour, the use of a suitable ring filter element may be mandated even when cutouts are present at the respective same location of the open end disc in different types of ring filter elements.

The ring filter element may include a fluid-permeable central tube which is arranged at the inner wall surface of the filter medium body and is fastened directly or indirectly to the filter medium body. The central tube supports the filter medium body, for example in case of a flow from the exterior to the interior in radial direction. The central tube may be designed like a grid with axial stays and circumferential stays.

At least one support element may be formed at the central tube and extends radially outwardly into the fold expansion. The support element of the central tube is part of the counter engagement element of the ring filter element. The support element is open in radially inward direction as a matter of principle. An engagement element of the positioning device may then engage radially outwardly the support element. The support element includes for example a cross section which tapers radially outwardly, for example tapers in a pointy manner. A central tube with such a support element simplifies the manufacture of the fold expansion at the inner circumference of the filter medium body in that the support element upon joining of folded bellows and central tube widens the fold which it engages.

The support element and the central tube together may be a single part. This further simplifies the manufacture.

A support segment may be formed at the open end disc, for example wherein the support segment and the open end disc are formed together as one piece. The support segment extends radially outwardly into the fold expansion. The support segment of the open end disc is part of the engagement element. The support segment includes for example a radially outwardly tapering cross section, for example tapering in a pointy manner. One or a plurality of folds in this embodiment may be widened during the manufacture of the ring filter element by a casting mold and may be fixed by the molded-on end disc in the spread-apart configuration. In this embodiment, additionally an element-fixed central tube, for example with the support element, may be provided. Typically, a housing-fixed central tube is employed in this embodiment.

The open end disc may include at least one continuously circumferentially extending seal for contact at a filter housing, for example wherein the seal is formed as a seal bead projecting in axial direction. In the mounted state, the seal separates a raw side (typically radially outward) from a clean side (typically radially inward, including the interior of the filter medium body). The seal may extend for example completely circumferentially around an opening of the open end disc which is in fluid communication with the interior of the filter medium body. The seal is provided as one piece together with the end disc. The seal bead may also be referred to as a seal collar.

In a further embodiment, it is provided that the seal surrounds the at least one cutout radially outwardly, for example wherein the seal in the region of the cutout includes a radially outwardly oriented bulge. In other respects, the seal may be circular. In the region of the cutout(s), the seal deviates thus from the circular shape. This ensures, on the one hand, sealing of the end disc, for example, in relation to the filter housing and/or a further ring filter element. On the other hand, a seal contour may be formed, for example, at the filter housing which corresponds to the seal with a bulge. In this way, only a ring filter element with a correspondingly bulging seal may be mounted. This ensures the use of a suitable ring filter element.

In an alternative embodiment, it is provided that the at least one cutout extends at the inner circumference of the seal in axial direction. For example, the seal at the inner circumference may include at least one recess which is aligned with the cutout. In other words, the recess at the inner circumference of the seal may form an extension of the cutout. A cross section of the seal may be reduced by the recess in radial direction. Here also, a seal contour at the filter housing may be shaped corresponding to the seal, for example, wherein the engagement element projects directly adjoining the seal contour. It is then only possible to mount a ring filter element with a seal when the recess (and thus the counter engagement element at the ring filter element) extends in axial direction across the entire height of the seal. This ensures the use of a suitable ring filter element.

The scope of the present invention also includes a filter device including a filter housing with at least one fluid inlet and at least one fluid outlet and furthermore including a ring filter element arrangement which is arranged in the filter housing and separates the fluid inlet from the fluid outlet, wherein the ring filter element arrangement includes at least a first ring filter element according to the invention, as described above. The filter device is an air filter device. The (first) ring filter element may be the only ring filter element of the ring filter element arrangement; as an alternative, the ring filter element arrangement may include, in addition to the first ring filter element, at least one or a plurality of further ring filter elements which for example may be arranged radially inside or radially outside of the first ring filter element. As needed, the provided further ring filter elements may be ring filter elements in accordance with the invention or not in accordance with the invention.

The filter device includes a positioning device with at least one radially outwardly extending engagement element, wherein the fold expansion at the inner wall surface of the filter medium body of the first ring filter element at least partially forms a counter engagement element and wherein the engagement element engages the counter engagement element. The cutout in the open end disc also at least partially forms the counter engagement element. The engagement element may be arranged at the filter housing or at a further ring filter element. The positioning device effects an unequivocal relative angular positioning of the ring filter element in relation to the filter housing or the further ring filter element of the filter device.

In an embodiment, the filter device includes a support tube which is fastened to the filter housing, for example non-releasably fastened, and which is arranged releasably in the interior of the filter medium body of the first ring filter element, wherein the engagement element of the positioning device is arranged at the support tube. In this way, the (first) ring filter element may be aligned in its rotational position in relation to the filter housing. In addition, the support tube centers the ring filter element in the filter housing and may support its filter medium radially inwardly. For example, the support tube may be locked, releasably or non-releasably, at the filter housing, for example in a defined angular position. As an alternative, the support tube may be screwed into the filter housing. The support tube is typically fluid-permeable. The fluid-permeable support tube may be designed as a type of grid with axial stays and circumferential stays.

In a first further development of this embodiment, a further filter medium body of a further ring filter element of the ring filter element arrangement is fastened indirectly or directly radially outwardly to the support tube. The further filter medium body may be, for example, a filter nonwoven which may be wound around the support tube. The at least one engagement element and the further filter medium body may be arranged sequentially in axial direction at the support tube. The filter medium body of the further ring filter element may include an adsorbent agent, for example active carbon. As an alternative or in addition, the further filter medium body arranged radially outwardly at the support tube may be a so-called secondary filter element or safety filter element.

In an alternative further development, an inner ring filter element of the ring filter element arrangement is arranged inside of the support tube and includes at its outer wall surface a second counter engagement element, wherein an engagement element of the support tube engages radially outwardly the (first) counter engagement element of the first ring filter element and an engagement element of the support tube engages radially inwardly the second counter engagement element of the inner ring filter element. The radially outwardly extending engagement element and the radially inwardly extending engagement element may be present at the same angular position. As an alternative or in addition, the radially outwardly extending engagement element and the radially inwardly extending engagement element may be one piece. In embodiments, the radially outwardly extending engagement element and the radially inwardly extending engagement element may however also be present at different angular positions and/or may be embodied separate from each other.

In this way, the two ring filter elements are aligned and fixed relative to each other in their angular position by the housing-fixed support tube. When the support tube is fastened in a defined angular position to the filter housing, a defined angular position of the two ring filter elements in relation to the filter housing is created additionally. A filter medium body of the inner ring filter element may include a folded bellows. The second counter engagement element of the inner ring filter element may be formed by a fold expansion at an outer wall surface of its filter medium body. The filter medium body of the inner ring filter element may include an adsorbent agent, for example active carbon.

As an alternative or in addition to the inner ring filter element, the ring filter element arrangement of the filter device may include an outer ring filter element with a filter medium body, wherein the filter medium body of the outer ring filter element encloses an interior, wherein the first ring filter element is received at least partially in the interior of the filter medium body of the outer ring filter element. A filter medium body of the outer ring filter element may include a folded bellows. In this embodiment, the filter medium body of the first ring filter element may include an adsorbent agent, for example active carbon.

The filter housing may include a housing positioning device for an unequivocal relative angular positioning of the outer ring filter element in relation to the filter housing, wherein the housing positioning device includes a housing engagement element which extends radially inwardly and engages a corresponding housing counter engagement element of the outer ring filter element. In this way, the outer ring filter element is fixed in a defined angular position in relation to the filter housing. The housing counter engagement element of the outer ring filter element may be formed with a fold expansion at an outer wall surface of the outer ring filter element.

As an alternative or in addition to the housing positioning device, the outer ring filter element may include a fluid-permeable inner tube arranged at the inner wall surface of the filter medium body of the outer ring filter element and fastened indirectly or directly to the filter medium body of the outer ring filter element, and wherein at the inner tube a further engagement element is arranged, for example is one piece together with the inner tube, wherein the further engagement element extends radially inwardly and engages a further counter engagement element at the outer wall surface of the filter medium body of the first ring filter element. In this way, the two ring filter elements are aligned and fixed relative to each other in their angular position by the inner tube of the outer ring filter element. When the first ring filter element (for example, by the housing-fixed support tube with the engagement element of the positioning device) or the outer ring filter element (for example, by the housing positioning device) is aligned in a defined angular position at the filter housing, at the same time a defined angular position of both ring filter elements in relation to the filter housing is provided. The fluid-permeable inner tube may be designed as a type of grid with axial stays and circumferential stays.

The filter device may include a cyclone element which is arranged upstream of the ring filter element arrangement. In other words, the cyclone element is arranged fluidally between the fluid inlet and the ring filter element arrangement with the at least one ring filter element. The cyclone element effects a pre-separation for example of coarse dust. In this way, the service life of the ring filter arrangement may be prolonged.

The invention concerns also the use of a filter device according to the invention as a cathode air filter of a fuel cell.

The scope of the present invention includes furthermore a fuel cell with an anode and a cathode between which an electrolyte is arranged and with a filter device according to the invention through which air may be supplied to the cathode.

Furthermore, the scope of the present invention includes a use of a ring filter element according to the invention in a filter device with a filter housing, wherein an engagement element arranged at the filter housing engages a fold expansion of the ring filter element. The advantages of the ring filter element may be utilized in this use.

### BRIEF DESCRIPTION OF THE DRAWINGS

Further features and advantages of the invention result from the following detailed description of embodiments of the invention with the aid of the accompanying drawing figures showing details according to the invention. The aforementioned and still further explained features may be realized individually by themselves or a plurality combined in any expedient combination in variants of the invention. The features illustrated in the drawings are illustrated such that the features and advantages according to the invention may be made clearly visible.

FIG. 1 shows in a schematic longitudinal section a first embodiment of a filter device according to the invention with a ring filter element arrangement comprising a first ring filter element according to the invention and an inner ring filter element arranged inside of the first ring filter element.

FIG. 2 shows the first ring filter element of the filter device of FIG. 1 in a schematic longitudinal section.

FIG. 3 shows the inner ring filter element of the filter device of FIG. 1 in a schematic longitudinal section.

FIG. 4 shows a schematic cross section through the filter device of FIG. 1 according to the section line 4-4 in FIG. 1.

FIG. 5 shows an enlarged detail of FIG. 4.

FIG. 6 shows an enlarged detail according to the detail 6 of FIG. 1.

FIG. 7 shows a second embodiment of a filter device according to the invention, with a ring filter element arrangement comprising an inner ring filter element according to the invention which is received in an outer ring filter element, in a schematic cross section which extends in a stepped manner so that a positioning device at the inner ring filter element and a further positioning device between the ring filter elements as well as a housing positioning device at the outer ring filter element are seen, even though they are arranged at different axial ends.

FIG. 8 shows an enlarged detail of FIG. 7.

FIG. 9 shows a detail of the filter device of FIG. 7 in a schematic longitudinal section in the region of the positioning device at an open end disc of the inner ring filter element.

FIG. 10 shows a detail of the filter device of FIG. 7 in a schematic longitudinal section in the region of closed end discs with the further positioning device between the two ring filter elements and the housing positioning device.

FIG. 11 shows the inner ring filter element according to the invention of the filter device of FIG. 7 in a schematic perspective view.

FIG. 12 shows a third embodiment of a filter device according to the invention with a ring filter element arrangement comprising an inner ring filter element according to the invention, which is received in an outer ring filter element, in a schematic longitudinal section.

FIG. 13 shows the inner ring filter element of the filter device of FIG. 12 in a schematic perspective view.

FIG. 14 shows a fourth embodiment of the filter device according to the invention, with a ring filter element arrangement comprising an inner ring filter element according to the invention, which is received in an outer ring filter element, in a schematic cross section which extends in a stepped manner so that a positioning device at the inner ring filter element and a housing positioning device at the outer ring filter element are seen even though they are arranged at different axial ends.

FIG. 15 shows in a schematic longitudinal section, a fifth embodiment of a filter device according to the invention with a ring filter element arrangement comprising an inner ring filter element according to the invention, which is received in an outer ring filter element according to the invention.

FIG. 16 shows the filter device of FIG. 15 in a schematic longitudinal section with a section plane rotated by 90° in comparison to FIG. 15.

FIG. 17 shows in a schematic longitudinal section a sixth embodiment of a filter device according to the invention with a ring filter element arrangement comprising an inner ring filter element according to the invention, which is received in an outer ring filter element.

FIG. 18 shows the filter device of FIG. 17 in a schematic longitudinal section with a section plane rotated by 90° in comparison to FIG. 17.

FIG. 19 shows a seventh embodiment of a filter device according to the invention in a schematic perspective view.

FIG. 20 shows a schematic section view of the filter device of FIG. 19, wherein a ring filter element according to the invention arranged in a filter housing is seen.

FIG. 21 shows the ring filter element of the filter device of FIG. 20 in a schematic perspective view.

FIG. 22 shows a schematic illustration of the cross section of a ring filter element according to the invention with a plurality of fold expansions in an arrangement having no rotational symmetry.

FIG. 23 shows a schematic illustration of an open end disc for a ring filter element according to the invention, wherein the end disc comprises a radially outwardly widening cutout.

FIG. 24 shows a schematic illustration of an open end disc for a ring filter element according to the invention, wherein the end disc comprises a radially outwardly widening cutout.

FIG. 25 shows in a schematic perspective view a further ring filter element according to the invention, wherein an open end disc comprises support segments for inwardly positioned fold expansions.

FIG. 26 shows in a schematic cross section, an eighth embodiment of a ring filter arrangement according to the invention with a ring filter element according to the invention, wherein a support tube engaging the ring filter element supports radially outwardly a further ring filter element.

FIG. 27 shows the support tube of the filter device of FIG. 26 in a schematic perspective view.

FIG. 28 shows a schematic illustration of a use according to the invention of a filter device according to the invention as a cathode air filter of a fuel cell.

### DETAILED DESCRIPTION

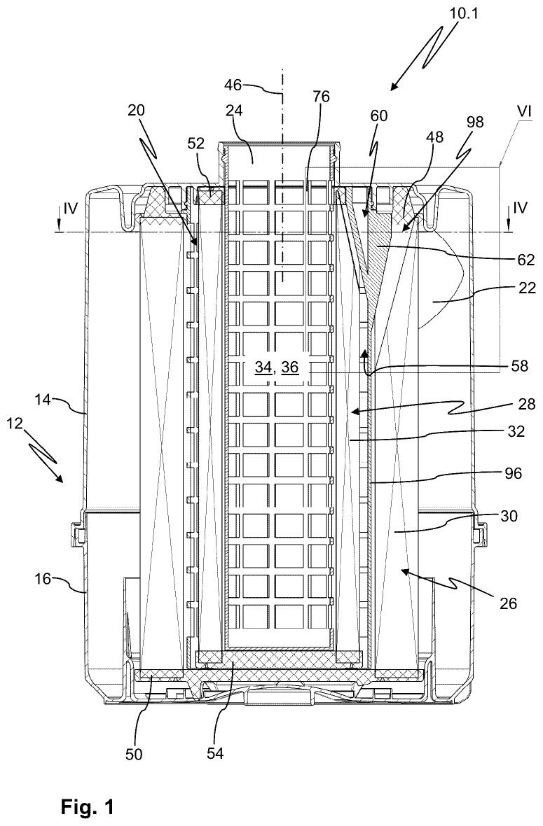

FIG. 1 shows a filter device 10.1, here in the form of an air filter. A filter housing 12 of the filter device 10.1 comprises a housing top part 14 and a housing bottom part 16 which are releasably connected to each other. A ring filter element arrangement 20 is received in the filter housing 12. The ring filter element arrangement 20 separates a fluid inlet 22 for unfiltered air from a fluid outlet 24 for filtered air. The fluid inlet 22 and the fluid outlet 24 are formed here in an exemplary fashion at the housing top part 14.

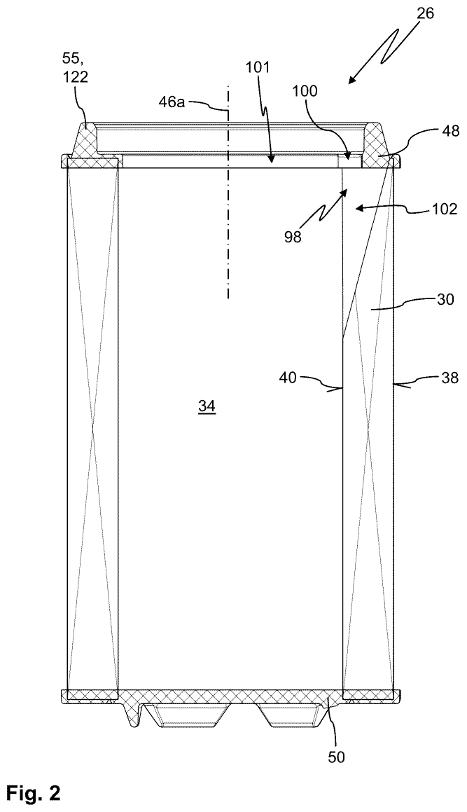

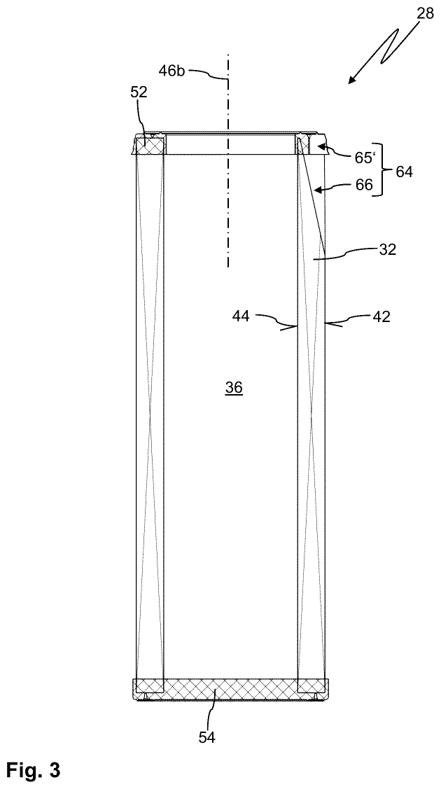

The ring filter element arrangement 20 comprises a first, here outer, ring filter element 26, see also FIG. 2, and a second, here inner, ring filter element 28, see also FIG. 3, which may be flowed through serially in radial direction from the exterior to the interior. The two ring filter elements 26, 28 each comprise a (first or second) filter medium body 30 or 32 which encloses a respective interior 34 or 36. The filter medium bodies 30, 32 are embodied hollow cylindrically with circular ring-shaped cross section, respectively. An outer wall surface of the first filter medium body 30 is identified by the reference character 38, an inner wall surface of the first filter medium body 30 is identified by the reference character 40 (FIG. 2). An outer wall surface of the second filter medium body 32 is identified by the reference character 42, an inner wall surface of the second filter medium body 32 is identified by reference character 44 (FIG. 3).

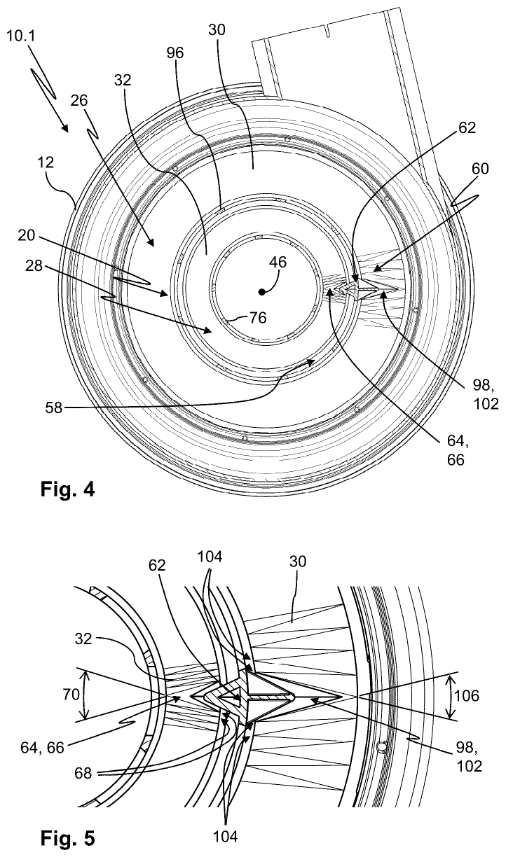

In the mounted state, the two ring filter elements 26, 28 are arranged coaxially to each other, compare FIG. 1 and FIG. 4. Longitudinal axes 46a, 46b of the filter medium bodies 30, 32 extending through the respective interiors 34, 36 coincide with a common longitudinal axis 46.

The two filter medium bodies 30, 32 are here formed as a folded bellows, respectively, which is obtained by a star-shaped folding of a flat filter medium. In FIG. 4, some of the respective folds are illustrated. The filter medium, for example that of the inner ring filter element 28 downstream in flow direction, may contain an adsorbent agent, for example, active carbon, in order to remove harmful gases from the air flow to be filtered.

Axial end faces of the two filter medium bodies 30, 32 are sealed by an end disc 48, 50, 52, 54, respectively. Presently, at one end closed end discs 50, 54 are provided, respectively. At the other end, open end discs 48, 52 are provided, respectively, in order to enable, on the one hand, the insertion of the inner ring filter element 28 into the outer ring filter element 26 and, on the other hand, to enable the exit of filtered air through the fluid outlet 24. In the mounted state, the open end discs 48, 52 here sealingly contact the housing top part 14, respectively. A seal 55 at the open end disc 48 of the first ring filter element 26 is embodied with a seal bead 122 projecting in axial direction (FIG. 2).

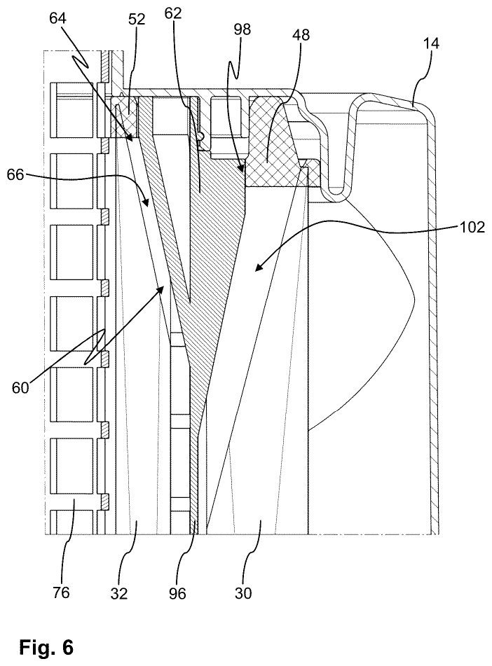

In the filter device 10.1, a support tube 96 is provided which is attached to the filter housing 12 and which extends between the two ring filter elements 26, 28, compare FIGS. 1 and 4. The region between the inner wall surface 40 of the first filter medium body 30 and the outer wall surface 42 of the filter medium body 32 is referred to also as an interface region 58 in the context of the present invention. The support tube 96 may be locked, for example, in a fixed angular position at the housing top part 14, compare for example FIG. 6. This angular position may be defined by the engagement of a housing-fixed axial projection in an end face recess at the support tube 96 (not illustrated in detail). For mounting, the two ring filter elements 26, 28 may be pushed onto the support tube 96 or inserted into the support tube 96 and, for demounting, may be pulled off the support tube 96.

A positioning device 60 is acting between the first and the second ring filter elements 26, 28 and holds the two ring filter elements 26, 28 relative to each other in a defined angular position (rotational position) in relation to the longitudinal axis 46, compare FIGS. 1 and 4. The positioning device 60 comprises an engagement element 62 which is arranged in the interface region 58 between the two ring filter elements 26, 28, compare also FIG. 5 as well as FIG. 6.

On the one hand, the engagement element 62 projects radially outwardly into a (first) counter engagement element 98 of the first ring filter element 26. In this way, an angular position of the first ring filter element 26 in relation to the longitudinal axis 46 is fixed relative to the filter housing 12. The engagement element 62 projects, on the other hand, radially inwardly into a (second) counter engagement element 64 of the second ring filter element 28. In this way, an angular position of the second ring filter element 28 in relation to the longitudinal axis 46 relative to the filter housing 12 is fixed. Since the engagement element 62 of the support tube 96 engages the counter engagement elements 64, 98 of both filter elements 26, 28, the latter are also fixed relative to each other in relation to the longitudinal axis 46 in a defined angular position; this applies even if the support tube 96 were held rotatably at the filter housing 12.

The counter engagement element 98 of the first ring filter element 26 comprises a cutout 100 which is formed at the open end disc 48 radially inwardly, compare also FIG. 2. In addition, the counter engagement element 98 comprises a fold expansion 102 aligned with the cutout 100 at the inner wall surface 40 of the first filter medium body 30. Here, the fold expansion 102 does not extend across the entire axial length of the first filter medium body 30 but is limited to less than one third of its entire length. In an embodiment, not illustrated in detail, the fold expansion could also extend across the entire length of the first filter medium body 30 from the open end disc 48 to the closed end disc 50.

The cutout 100 is radially inwardly open here. In other words, the cutout 100 passes immediately into a central opening 101 of the open end disc 48. The cutout 100 may thus also be viewed as a bulge in the rim of the central opening 101. The central opening 101 as well as the cutout 100 are surrounded at the outer side by the seal bead 122.

In the region of the fold expansion 102, a fold distance between the radial inner fold edges 104 of the first filter medium body 30 which is measured in circumferential direction is enlarged compared to the fold distance of adjoining inner fold edges 104, compare for example FIG. 5. Here, the fold expansion 102 is limited to a single inwardly open fold. A fold angle 106 is also enlarged due to the fold expansion 102 compared to the adjoining folds.

The counter engagement element 64 of the inner ring filter element 28 is formed by a cutout 65′ in the open end disc 52 (compare for example FIG. 3) as well as a fold expansion 66 at the outer wall surface 42 of the star-shaped folded filter medium body 32 (compare for example FIG. 5). The cutout 65′ and the fold expansion 66 are aligned with each other, compare for example FIG. 3.

In the region of the fold expansion 66, a fold distance measured in circumferential direction between radially outer fold edges 68 of the second filter medium body 32 is enlarged in comparison to the fold distance of adjoining outer fold edges 68. Here, the fold expansion 66 is limited to a single outwardly open fold. A fold angle 70 is enlarged also due to the fold expansion 66 compared to the adjoining folds. Here, the fold expansion 66 does not extend across the entire axial length of the second filter medium body 32 but is limited to less than a third of its entire length. In an embodiment, not illustrated in detail, the fold expansion could extend across the entire length of the second filter medium body 32 from the open end disc 52 to the closed end disc 54.

A central tube 76 which may be arranged fixedly at the housing, for example, may be locked to the housing top part 14, and may support the second ring filter element 28 at its inner wall surface 44 radially inwardly, compare FIG. 1.

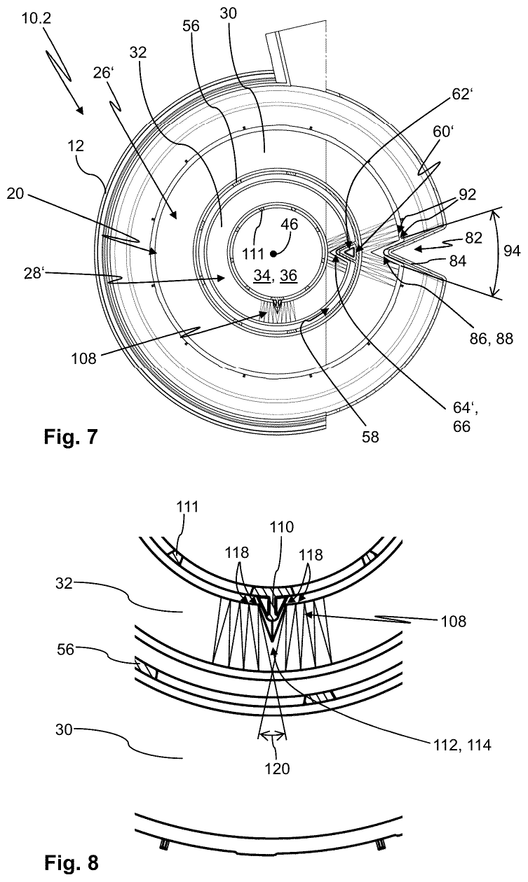

FIG. 7 shows a second filter device 10.2. The filter device 10.2 of FIG. 7 corresponds in many respects to the filter device 10.1 illustrated in FIGS. 1 to 6 and described above. In the following, primarily the differences will be explained; in other respects, reference is being had to the above description.

The filter device 10.2 comprises a ring filter element arrangement 20 with a first, here inner, ring filter element 28′ and outer ring filter element 26′. The ring filter elements 26′, 28′ are arranged coaxially to a common longitudinal axis 46 in a filter housing 12. The filter medium body 32 of the first inner ring filter element 28′ is surrounded at the exterior side by filter medium body 30 of the outer ring filter element 26′; in other words, the filter medium body 32 is received in an interior 34 of the filter medium body 30.

Here, the filter medium bodies 30, 32 of the two ring filter elements 26′, 28′ are also formed by star-shaped folded filter bellows. The ring filter elements 28′, 26′of the ring filter element arrangement 20 may be flowed through serially radially from the exterior to the interior. The filter medium body 30 of the outer ring filter element 26′ is therefore also referred to as first filter medium body 30; the filter medium body 32 of the first inner ring filter element 28′ is correspondingly referred to also as second filter medium body 32.

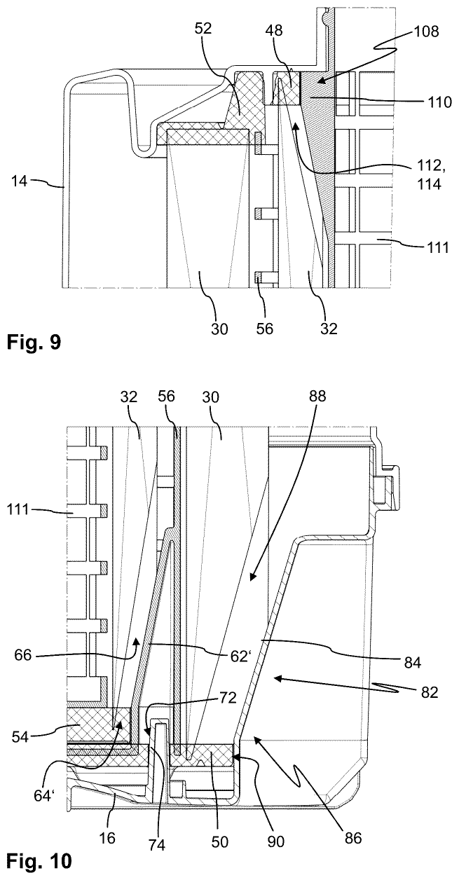

In the filter device 10.2, a positioning device 108 is provided which aligns the first inner ring filter element 28′ relative to the filter housing 12 in a defined angular position in relation to the longitudinal axis 46. The positioning device 108 comprises an engagement element 110, compare also FIGS. 8 and 9. The engagement element 110 is formed as a radially outwardly pointing projection at a housing-fixed support tube 111. The support tube 111 may be locked in a defined angular position at the housing top part 14.

The engagement element 110 engages a counter engagement element 112 at the first ring filter element 28′. The counter engagement element 112 comprises a fold expansion 114 at the inner wall surface 44 of the second filter medium body 32 (compare for example FIG. 8) as well as a cutout 116 radially inwardly at its open end disc 52, compare FIG. 11. Here, the fold expansion 114 does not extend across the entire axial length of the second filter medium body 32 but is limited to less than one fourth of the entire length, compare FIG. 9.

In the region of the fold expansion 114, a fold distance measured in circumferential direction between radially inner fold edges 118 of the second filter medium body 32 is enlarged in comparison to the fold distance of adjoining inner fold edges 118, compare FIG. 8. Here, the fold expansion 114 is limited to a single inwardly open fold. A fold angle 120 is also enlarged due to the fold expansion 114 in comparison to the adjoining folds.

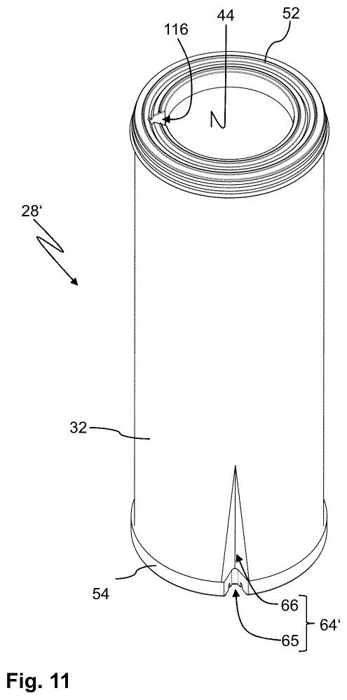

In the filter device 10.2, a further positioning device 60′ is additionally formed between the two ring filter elements 26′, 28′ with a further engagement element 62′ in the form of a radially inwardly pointing projection at an inner tube 56 which is fixedly connected to the outer ring filter element 26, compare also FIG. 10. The further engagement element 62′ engages a further counter engagement element 64′ at the first inner ring filter element 28′ which here is formed also by a fold expansion 66 at the outer wall surface 42 of the second filter medium body 32 (compare in this respect also FIG. 5). In addition, the further counter engagement element 64′ comprises a cutout 65, aligned with the fold expansion 66, at the closed end disc 54, compare FIG. 11. The further counter engagement element 64′ may be displaced in circumferential direction in relation to the counter engagement element 112, for example, by 90°, compare also FIG. 7.

In the filter device 10.2, the engagement element 62′ comprises at the end face (in the region of the end disc 50) a recess 72, compare FIG. 10. The otherwise closed end disc 50 is also perforated in the region of the recess 72. The further engagement element 62′ is, however, fluid-tightly closed and embedded seal-tightly in the end disc 50 so that the outer ring filter element 26′ remains sealed at the bottom end.

A housing-fixed axial projection 74, which here is embodied as one piece together with the housing bottom part 16, engages the recess 72 of the further engagement element 62′. In other words, the axial projection 74 passes through the end disc 50 into the hollow engagement element 62′.

By engagement of the axial projection 74 in the recess 72 of the further engagement element 62′, a defined angular position of the outer ring filter element 26′ in relation to the filter housing 12 is achieved. By engagement of the further engagement element 62′ in the further counter engagement element 64′ of the first inner ring filter element 28′; the first ring filter element 28′ (indirectly through the outer ring filter element 26′) is thus also angularly positioned relative to the filter housing 12. The further engagement element 62′ connected fixedly to the outer ring filter element 26′ effects thus an angular positioning of the two ring filter elements 26′, 28′ of the ring filter element arrangement 20 in relation to each other as well as of the ring filter element arrangement 20 as a whole in relation to the filter housing 12.

In the filter device 10.2, furthermore the housing positioning device 82 is provided which aligns the outer ring filter element 26′ relative to the filter housing 12 in a defined angular position in relation to the longitudinal axis 46, compare FIGS. 7 and 10. The housing positioning device 82 comprises a housing engagement element 84 which is in the form of a wedge-shaped rib which, for example, may be one piece together with the housing bottom part 16. The housing engagement element 84 tapers toward the top and projects less far radially inwardly in upward direction. In axial direction, the height of the first housing engagement element 84 is limited to less than one fourth of the length of the first filter medium body 30.

The housing engagement element 84 engages a housing counter engagement element 86 at the outer ring filter element 26′. The housing counter engagement element 86 comprises a fold expansion 88 at the outer wall surface 38 of the first filter medium body 30 as well as a cutout 90 in its closed end disc 50, compare FIGS. 7 and 10. Here, the fold expansion 88 does not extend across the entire axial length of the first filter medium body 30 but is limited to less than one third of its entire length.

In the region of the fold expansion 88, a fold distance measured in circumferential direction between the radially outer fold edges 92 of the first filter medium body 30 is enlarged in comparison to the fold distance of adjoining outer filter fold edges 92. Here, the fold expansion 88 is limited to a single outwardly open fold. A fold angle 94 is also enlarged due to the fold expansion 88 in comparison to the adjoining folds.

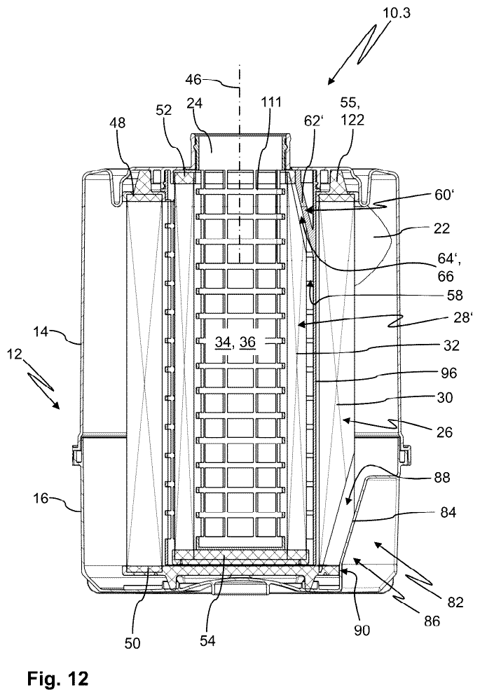

FIG. 12 shows a third filter device 10.3. The filter device 10.3 of FIG. 12 corresponds in many aspects to the filter device 10.2 illustrated in FIGS. 7 to 11 and described above. In the following, primarily the differences will be explained; in other respects, reference is being had to the above description.

The filter device 10.3 comprises, like the filter device 10.2, a positioning device 108 which aligns a first inner ring filter element 28′ in relation to the filter housing 12 in a defined angular position in relation to a longitudinal axis 46 in that an engagement element 110 of a housing-fixed support tube 111 engages a counter engagement element 112, wherein the counter engagement element 112 is formed by a cutout 116 at the inner circumference of the end disc 52 and an adjoining fold expansion 114 (in FIG. 12, the positioning device 108 is in front of the drawing plane and is therefore not visible, compare FIG. 9 in this respect). Likewise, as in the filter device 10.2, the filter device 10.3 is provided with a housing positioning device 82 which angularly positions an outer ring filter element 26′ relative to the filter housing 12 in that a housing engagement element 84 engages a housing counter engagement element 86, wherein the housing counter engagement element 86 is formed by a cutout 90 at the outer circumference of the end disc 50 and an adjoining fold expansion 88.

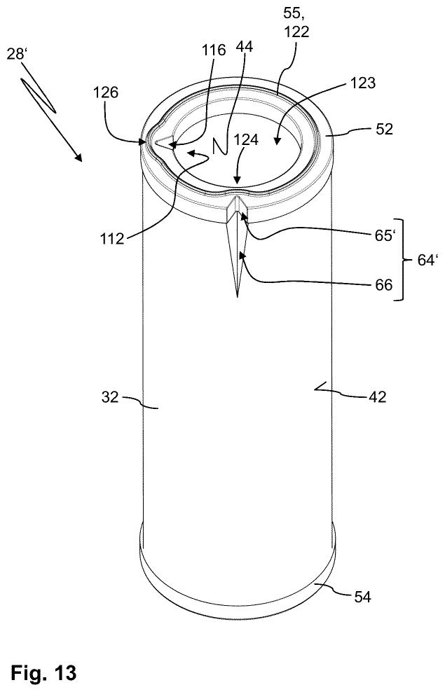

In contrast to the filter device 10.2, a further positioning device 60′ is arranged in the filter devices 10.3 in the region of the open end disc 52 of the first inner ring filter element 28′. In the illustrated embodiment, a further engagement element 62′ of the further positioning device 60′ is in the form of a radially inwardly pointing projection at a housing-fixed support tube 96. As an alternative, the further engagement element 62′ could be provided at an inner tube fastened to the outer ring filter element 26′ (not illustrated in detail, compare FIGS. 9 and 10 in this respect). The further engagement element 62′ engages radially inwardly a further counter engagement element 64′ at the first inner ring filter element 28′ which here also is formed with a fold expansion 66 at the outer wall surface 42 of the second filter medium body 32 (compare also FIG. 5 in this respect). In addition, the further counter engagement element 64′ comprises a cutout 65′ aligned with the fold expansion 66 at the open end disc 52, compare FIG. 13. The further counter engagement element 64′ is displaced in circumferential direction in comparison to the counter engagement element 112, for example, by 90°.

The ring filter element 28′ comprises at the open end disc 52 a seal 55 in the form of an axially projecting seal bead 122. The seal bead 122 surrounds at the outer side a central opening 123 including the inward cutout 116 which is open toward the central opening 123. The seal bead 122 extends radially inwardly past the outward cutout 65′. In the region of the cutouts 65′ and 116, the seal 55 comprises a depression 124 in radially inward direction or a bulge 126 in radially outward direction. In this respect, the otherwise circular seal bead 122 deviates from the circular shape in these regions.

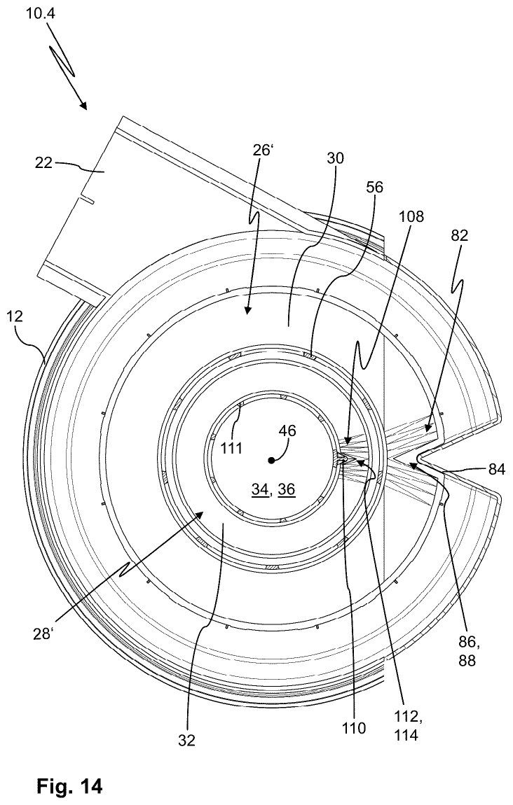

FIG. 14 shows a fourth filter device 10.4. The filter device 10.4 of FIG. 14 corresponds in many aspects to the filter device 10.2 illustrated in FIGS. 7 to 11 and described above. In the following, primarily the differences will be explained; in other respects, reference is being had to the above description.

The filter device 10.4 comprises, like the filter device 10.2, a positioning device 108 which aligns a first inner ring filter element 28′ relative to the filter housing 12 in a defined angular position in relation to a longitudinal axis 46 in that an engagement element 110 engages a counter engagement element 112, wherein the counter engagement element 112 is formed by a cutout 116 at the inner circumference of the end disc 52 and an adjoining fold expansion 114. A support tube 111 at which the engagement element 110 is formed may be locked in a defined angular position to the housing top part 14, compare in this respect FIG. 9.

Likewise, as in the filter device 10.2, a housing positioning device 82 is provided in the filter device 10.4 which angularly positions an outer ring filter element 26′ relative to the filter housing 12 in that a housing engagement element 84 engages a housing counter engagement element 86, wherein the housing counter engagement element 86 is formed by a cutout 90 at the outer circumference of the end disc 50 and an adjoining fold expansion 88, compare in this respect also FIGS. 7 and 10.

An inner tube 56 of the outer ring filter element 26′ supports its filter medium body 30 radially inwardly. In the filter device 10.4, the inner tube 56 does not participate in the angular positioning of the ring filter elements 26′, 28′.

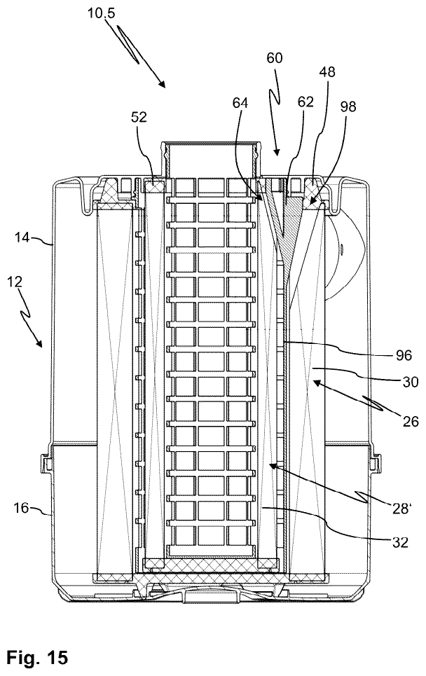

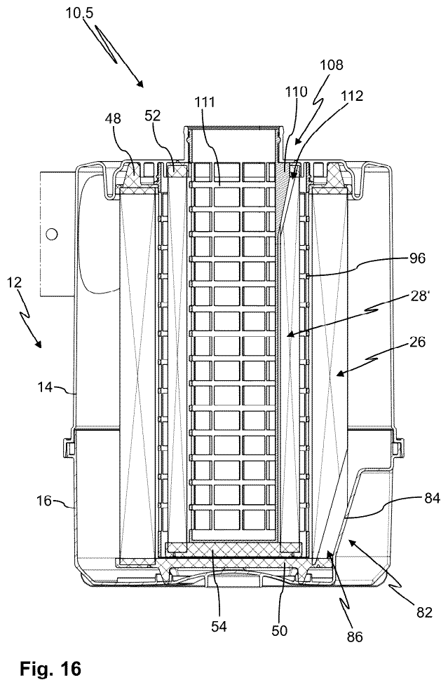

FIGS. 15 and 16 show a fifth filter device 10.5. The filter device 10.5 of FIGS. 15 and 16 corresponds in many aspects to the filter device 10.1 which is illustrated in FIGS. 1 to 6 and described above. In the following, primarily the differences will be explained, in other respects, reference is being had to the above description.

In the filter device 10.5, there is also a positioning device 60 provided which acts between two coaxial ring filter elements 26, 28′, compare FIG. 15. An engagement element 62 which is formed at a housing-fixed support tube 96 engages radially outwardly a corresponding counter engagement element 98 at an open end disc 48 of the outer ring filter element 26. The counter engagement element 98 is formed by an inward fold expansion 102 at the star-shaped folded filter medium body 30 and a cutout 100 aligned therewith at the inner circumference of the end disc 48, compare in this respect also FIGS. 2 and 5. In addition, the engagement element 62 engages radially inwardly a corresponding counter engagement element 64 at an open end disc 52 of the second ring filter element 28′, compare in this respect also FIGS. 3 and 5.

Furthermore, the filter device 10.5 comprises a (second) positioning device 108, compare FIG. 16. As in the filter device 10.2, an engagement element 110, which is formed at the support tube 111 attached to the housing top part 14, engages radially outwardly a corresponding radially inwardly open counter engagement element 112 in the region of the upper end disc 52 of the inner ring filter element 28′; in this respect, reference is being had to the above description and FIGS. 7, 8, and 9. The second ring filter element 28′ of the filter device 10.5 corresponds to the ring filter element 28′ which is shown in FIG. 13 and described above.

Furthermore, the filter device 10.5 comprises a housing positioning device 82, compare FIG. 16. As in the filter devices 10.2, 10.3, and 10.4, a housing engagement element 84, which is formed at the housing bottom part 16, engages radially inwardly a corresponding radially outwardly open housing counter engagement element 86 in the region of the closed end disc 50 of the first ring filter element 26; reference is being had to the above description and FIGS. 7 and 10 in this respect.

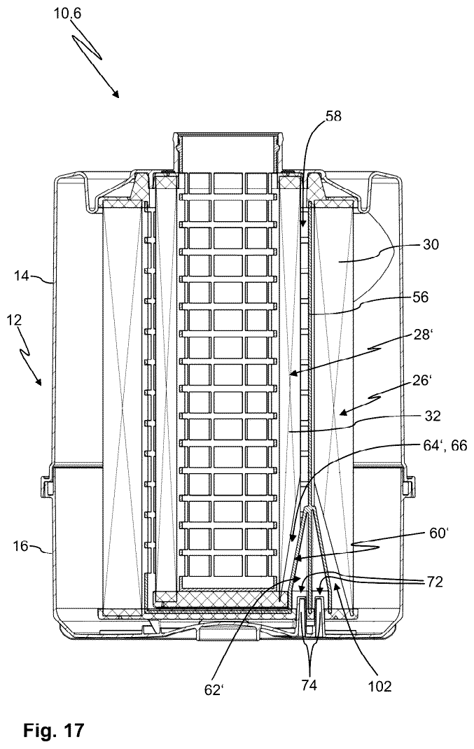

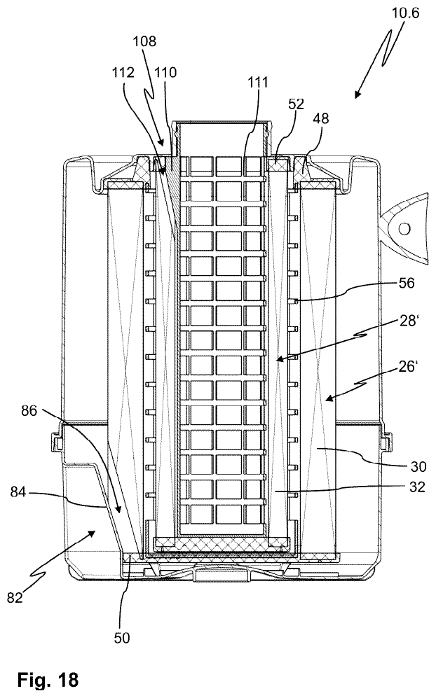

FIGS. 17 and 18 show a sixth filter device 10.6 which corresponds in many aspects to the filter device 10.2 of FIG. 7. In the following, primarily the differences will be explained; in other respects, reference is being had to the above description.

The filter device 10.6 comprises a positioning device 108, compare FIG. 18. As in the filter device 10.2, an engagement element 110 arranged at the housing top part 14 and formed at a support tube 111 fastened to the housing top part 14 engages radially outwardly a corresponding radially inwardly open housing counter engagement element 112 in the region of an open end disc 52 of an inner ring filter element 28′; reference is being had in this respect to the above description and to FIGS. 7, 8 and 9. The ring filter element 28′ of the filter device 10.6 corresponds to the ring filter element 28′ which is illustrated in FIG. 11 and described above.

A further positioning device 60′ between the inner ring filter element 28′and an outer ring filter element 26′ is formed by an engagement element 62′ in the form of a radially inwardly pointing projection at an inner tube 56 which is fixedly connected to the outer ring filter element 26′, compare FIG. 17. The engagement element 62′ engages a counter engagement element 64′ at the inner ring filter element 28′ which here is formed also by a fold expansion 66 at the outer wall surface 42 of the second filter medium body 32 (compare in this respect also FIG. 5). At the engagement element 62′, there is also a radially outwardly pointing projection formed which engages a fold expansion 102 at the inner wall surface 40 of the first filter medium body 30. The engagement element 62′ is provided with two end face recesses 72, of which a respective one opens either the inward or the outward projection protruding away from the inner tube 56. Each one of the recesses 72 is engaged by an axial projection 74 of the filter housing 12. Here, the axial projections 74 are formed as one piece together with the housing bottom part 16.

In addition, the filter device 10.6 comprises a housing positioning device 82, compare FIG. 18. As in the filter device 10.2, a first housing engagement element 84 formed at the housing bottom part 16 engages radially inwardly a corresponding radially outwardly open housing counter engagement element 86 in the region of the closed end disc 50 of the first ring filter element 26′; in this respect, reference is being had to the above description and FIGS. 7 and 10.

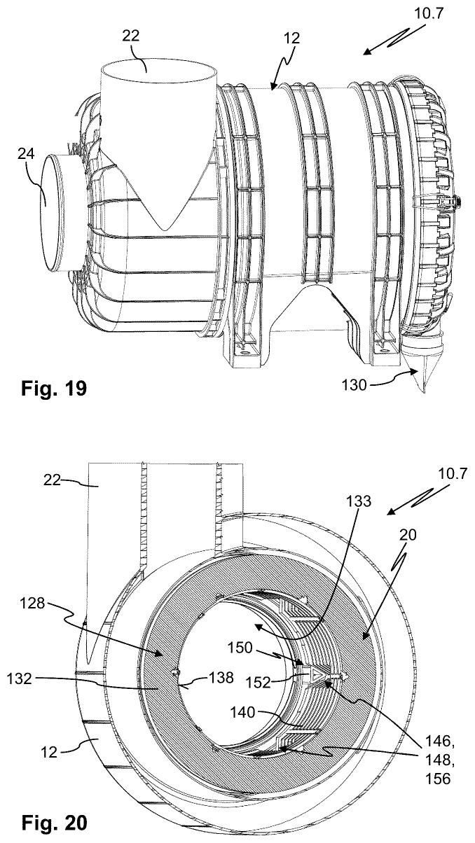

FIGS. 19 and 20 show a filter housing 12 of a seventh filter device 10.7. The filter housing 12 comprises a fluid inlet 22 and a fluid outlet 24. In the filter housing 12, a ring filter element 128 is received which may be flowed through in radial direction from the exterior to the interior and which represents here the only ring filter element of the ring filter arrangement 20, compare FIG. 20. Fluidally upstream of the ring filter element 128, a cyclone element is arranged, which may provide a pre-separation, for example of coarse dust. The cyclone element comprises at least one dust discharge valve 130, see FIG. 19.

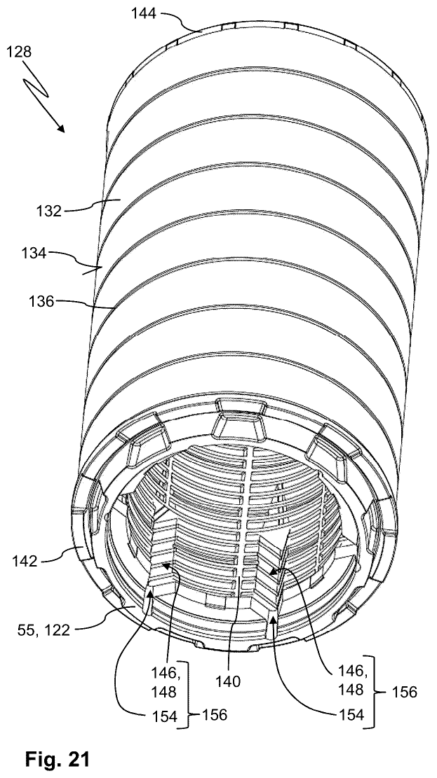

The filter medium body 132 of the ring filter element 128 is designed as a folded bellows which encloses an interior 133, compare for example FIG. 20. At an outer wall surface 134, the filter medium body 132 is stabilized by a spiral-wound string 136, see FIG. 21. At an inner wall surface 138, compare also FIG. 20, a central tube 140 is arranged which here is formed by axial stays and circumferential stays. The central tube 140 at one end is embedded in an open end disc 142, compare FIG. 21. At the other end, the central tube 140 is embedded in a closed end disc 144 (FIG. 21).

The filter medium body 132 is provided at the inner wall surface 138 with a plurality of fold expansions 146. The central tube 140 comprises for each one of the fold expansions 146 a support element 148 which engages radially outwardly the respective fold expansion 146. The support elements 148 are here embodied as projections formed integrally in the central tube 140 and extending radially outwardly in a pointed manner and as one piece together with the central tube 140.

In the illustrated embodiment, the fold expansions 146 and the cutouts 154 are distributed uniformly at the inner circumference of the filter medium body 132. As an alternative, the fold expansions 146 and cutouts 154 of the open end disc 142 may be distributed in a pattern that is not rotationally symmetric about the longitudinal axis 149 of the ring filter element 128, see FIG. 22.

For angular positioning of the ring filter element 128 in relation to the filter housing 12, a positioning device 150 comprises an engagement element 152, here in the form of an axial projection, at the filter housing 12, compare FIG. 20. The engagement element 152 engages one of the fold expansions 146. In order to enable the engagement of the axially extending engagement element 152, the open end disc 142 at its inner circumference is provided with a plurality of cutouts 154, wherein respectively one of the cutouts 154 is aligned with one of the fold expansions 146, compare FIG. 21. The cutouts 154 extend in this context also at the inner circumference of a seal bead 122 which in axial direction projects away from the end disc 142 and forms a circumferential seal 55. A respective one of the fold expansions 146 with the corresponding support element 148 and the corresponding cutout 154 form a counter engagement element 156 for the engagement element 152.

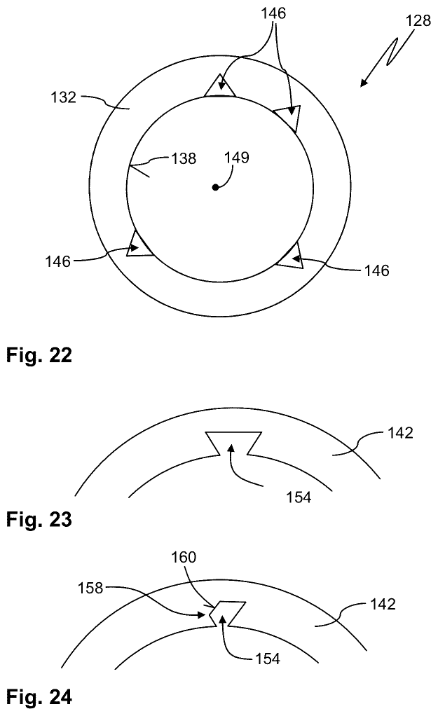

In the ring filter element 128, the cutouts 154 in the open end disc 142 taper radially outwardly, compare for example FIG. 21. As an alternative, at least one cutout 154 in the end disc 142 could widen radially outwardly, compare FIG. 23. It is also possible that at least one of the cutouts 154 in the end disc 142 comprises at least one kink 158 in at least one of its lateral edges 160, compare FIG. 24. Engagement element 152 comprises then typically a corresponding cross section (not illustrated in detail). These configurations of the cutouts and of the engagement element are also conceivable in the afore described ring filter elements 26, 26′, 28, 28′.

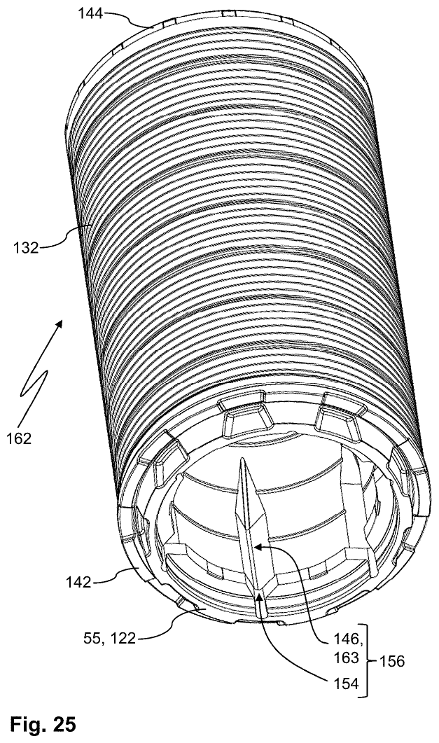

FIG. 25 shows a further ring filter element 162 which in many aspects corresponds to the ring filter element 128 of FIG. 21. In the following, therefore only the differences will be explained; in other respects, reference is being had to the above description. The ring filter element 162 is formed at an inner wall surface 138 without central tube. In other words, inner fold edges of the filter medium body 132 embodied as a filter bellows may be exposed at the inner wall surface 138. The ring filter element 162 may be stabilized at its inner wall surface 138 by at least one inner spiral-wound string which for example also holds the shape of the fold expansions 146 so that neighboring inner fold edges are positioned at a predetermined enlarged distance 163 relative to each other. In embodiments, the ring filter element 162 comprises a plurality of inner spiral-wound string spaced apart in the direction of the longitudinal axis.

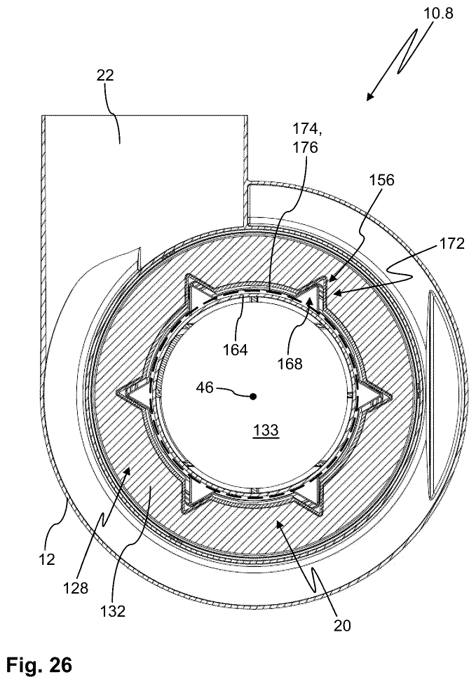

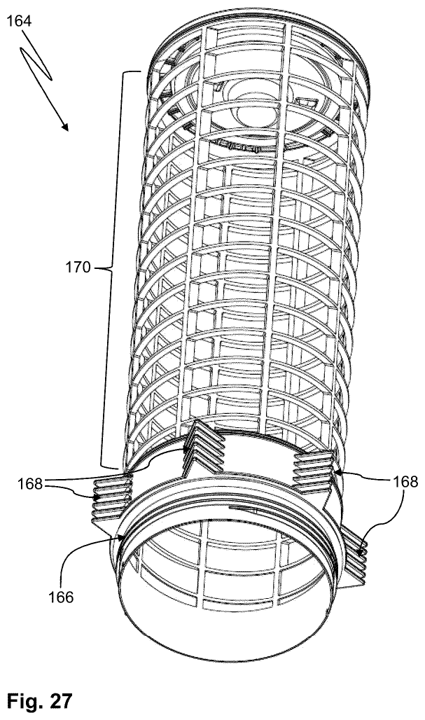

FIG. 26 shows an eighth filter device 10.8. In a filter housing 12, which corresponds substantially to the filter housing illustrated in FIG. 19, a ring filter element, for example, the above-described ring filter element 128 illustrated in FIG. 21, is received. A support tube 164, which is illustrated by itself in FIG. 27, and which here is formed with axial stays and circumferential stays, engages the interior 133 of the ring filter element 128. The support tube 164 comprises at an axial end a threaded section 166, by means of which it is screwed to a corresponding counter thread of the filter housing 12. Furthermore, the support tube 164 comprises at least one engagement element 168 which here is formed by projections triangular in cross section. Presently, six engagement elements 168 are provided distributed about the circumference. The engagement elements 168 are arranged in the illustrated embodiment between the threaded section 166 and a grid-shaped tubular body 170 of the support tube 164. In the mounted state of the filter device 10.8, compare FIG. 26, each of the engagement elements 168 engages one of the counter engagement elements 156 of the ring filter element 128. In this way, a positioning device 172 formed by the engagement elements 168 and the counter engagement elements 156 fixes the ring filter element 128 in one of several, here six, possible angular positions in the filter housing 12.

Radially outwardly at the tubular body 170, a further ring filter element 174 is arranged which in FIG. 26 is illustrated by a dashed line. The ring filter element 174 is embodied with a further filter medium body 176, here in the form of a filter nonwoven, wherein the filter medium body 176 is wound about the tubular body 170. The further filter medium body 176 is received in radial direction between the support tube 164 and the filter medium body 132 of the ring filter element 128. The two ring filter elements 128 and 174 of the ring filter element arrangement 20 are arranged coaxially to a common longitudinal axis 46.

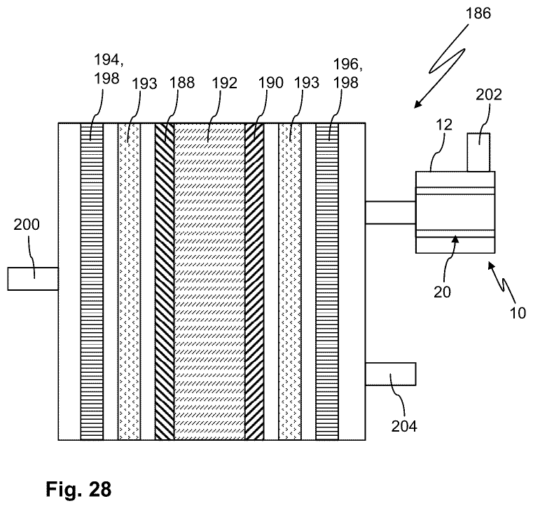

FIG. 28 shows a fuel cell 186. The fuel cell 186 comprises an anode 188, a cathode 190, and an electrolyte 192 arranged between them. The anode 188 and the cathode 190 may adjoin outwardly a gas diffusion layer 193, respectively. The anode 188 and the cathode 190 may be received between lateral parts 194, 196 of a bipolar plate 198. Through the lateral part 194 of the bipolar plate 198, hydrogen may be supplied from the hydrogen inlet 200 to the anode 188. Through the lateral part 196 of the bipolar plate 198 oxygen or air containing oxygen may be supplied from an air inlet 202 to the cathode 190. Between the air inlet 202 and the cathode 190, a filter device 10, for example, one of the above-described filter devices 10.1 to 10.8 with a ring filter element arrangement 20 arranged in a filter housing 12, is provided. The filter device 10 functions thus as a cathode filter. Water produced in the fuel cell 186 may be discharged through a water outlet 204. Electrical connections of the fuel cell 186 are not illustrated in detail.

In summary, the invention concerns a ring filter element with a filter medium body in the form of a folded bellows which comprises radially inwardly at least one fold expansion which adjoins an open end disc. The open end disc comprises at least one cutout. The cutout and the fold expansion are arranged in overlap with each other. At the axial end, which is facing away from the open end disc, the filter medium body is sealed by a closed end disc. In use of the ring filter element in a filter device, an engagement element engages the fold expansion and/or the cutout. The engagement element may be formed at a filter housing or at a further ring filter element of the filter device. Thus, an angular position of the ring filter element in relation to the filter housing or the further ring filter element is fixed.

### REFERENCE CHARACTERS

filter device 10.1; 10.2; 10.3; 10.4; 10.5; 10.6; 10.7; 10.8; 10
filter housing 12
housing top part 14
housing bottom part 16
ring filter element arrangement 20
fluid inlet 22
fluid outlet 24
first outer ring filter element 26
outer ring filter element 26′
inner ring filter element 28
first inner ring filter element 28′
filter medium body 30 of the outer ring filter element 26/26′
filter medium body 32 of the inner ring filter element 28/28′
interior 34 of the outer ring filter element 26/26′
interior 36 of the inner ring filter element 28/28′
outer wall surface 38 of the filter medium body 30
inner wall surface 40 of the filter medium body 30
outer wall surface 42 of the filter medium body 32
inner wall surface 44 of the filter medium body 32
longitudinal axis 46a of the ring filter element 26/26′
longitudinal axis 46b of the ring filter element 28/28′
common longitudinal axis 46
open end disc 48 of the ring filter element 26/26′
closed end disc 50 of the ring filter element 26/26′
open end disc 52 of the ring filter element 28/28′
closed end disc 54 of the ring filter element 28/28′
seal 55 at the open end disc 48
inner tube 56 of the ring filter element 26′
interface region 58
positioning device 60
further positioning device 60′
engagement element 62
further engagement element 62′
counter engagement element 64 of the ring filter element 28
further counter engagement element 64′ of the ring filter element 28′
cutout 65 radially outward in the end disc 54
cutout 65′ radially outward in the end disc 52
fold expansion 66 at the outer wall surface 42 of the second filter medium body 32
radially outer fold edges 68 of the second filter medium body 32
fold angle 70
recess 72
Axial Projection 74 at the Filter Housing 12
central tube 76
housing positioning device 82
housing engagement element 84
housing counter engagement element 86
fold expansion 88 at the outer wall surface 38 of the filter medium body 30
cutout 90 radially outward in the end disc 50
radially outer fold edges 92 of the filter medium body 30
fold angle 94
housing-fixed support tube 96
counter engagement element 98 of the ring filter element 26
cutout 100 radially inward in the end disc 48
central opening 101 of the open end disc 48
fold expansion 102 at the inner wall surface 40 of the filter medium body 30
radially inner fold edges 104 of the first filter medium body 30
fold angle 106
positioning device 108
engagement element 110
housing-fixed support tube 111
counter engagement element 112 at the ring filter element 28′
fold expansion 114 at the inner wall surface 44 of the filter medium body 32
cutout 116 radially inward in the end disc 52
radially inner fold edges 118 of the filter medium body 32
fold angle 120
seal bead 122
central opening 123 of the open end disc 52
depression 124
bulge 126
ring filter element 128; 162
dust discharge valve 130
filter medium body 132
interior 133 of the ring filter element 128/162
outer wall surface 134 of the ring filter element 128/162
spiral-wound string 136
inner wall surface 138 of the ring filter element 128/162
central tube 140
open end disc 142 of the ring filter element 128/162
closed end disc 144 of the ring filter element 128/162
fold expansion 146 at inner wall surface 138 of the ring filter element 128/162
support element 148
longitudinal axis 149 of the ring filter element 128/162
positioning device 150
engagement element 152
cutout 154 radially inward in the end disc 142
counter engagement element 156
kink 158
lateral edge 160
enlarged spacing of fold edges 163
housing-fixed support tube 164
threaded section 166
engagement element 168
tube body 170
positioning device 172
further ring filter element 174
further filter medium body 176
fuel cell 186
anode 188
cathode 190
electrolyte 192
gas diffusion layer 193
lateral parts 194, 196
bipolar plate 198
hydrogen inlet 200
air inlet 202
water outlet 204

That which is claimed is:

1. A ring filter element for air filtration, the ring filter element comprising:
a filter medium body enclosing an interior;
an open end disc and a closed end disc, wherein the open end disc and the closed end disc seal-tightly delimit the filter medium body in an axial direction;
wherein the filter medium body comprises a folded bellows comprising folds, wherein the folded bellows comprises an inner wall surface comprising a fold expansion; and
wherein the open end disc comprises a cutout aligned with the fold expansion.

2. The ring filter element according to claim 1, wherein the fold expansion comprises a fold angle which is larger than a fold angle of a plurality of the folds of the folded bellows and/or wherein the fold expansion comprises a fold distance which is larger than a fold distance of a plurality of the folds of the folded bellows.

3. The ring filter element according to claim 1, wherein the folded bellows comprises a height, and wherein the fold expansion extends across a portion of the height of the folded bellows.

4. The ring filter element according to claim 1, wherein the inner wall surface comprises a plurality of the fold expansion distributed around the inner wall surface, and wherein the open end disc comprises a plurality of the cutout, wherein each one of the plurality of the cutout is aligned with a corresponding one of the plurality of the fold expansion.

5. The ring filter element according to claim 4, wherein the plurality of the fold expansion and the plurality of the cutout are arranged in relation to a longitudinal axis of the ring filter element in a pattern which has no rotational symmetry.

6. The ring filter element according to claim 1, wherein the cutout of the open end disc is open radially inwardly.

7. The ring filter element according to claim 1, wherein the cutout tapers radially outwardly.

8. The ring filter element according to claim 1, wherein the cutout widens radially outwardly.

9. The ring filter element according to claim 1, further comprising a fluid-permeable central tube arranged at the inner wall surface of the filter medium body and attached to the filter medium body, and wherein at least one support element is arranged at the central tube.

10. The ring filter element according to claim 9, wherein the at least one support element and the central tube together form one piece, wherein the at least one support element extends radially outwardly into the fold expansion.

11. The ring filter element according to claim 1, wherein the open end disc comprises at least one continuous circumferential seal bead projecting in the axial direction.

12. A filter device comprising:
a filter housing comprising at least a fluid inlet and a fluid outlet;
a ring filter element arrangement arranged in the filter housing and separating the fluid inlet from the fluid outlet, wherein the ring filter element arrangement comprises a first ring filter element, wherein the first ring filter element is a ring filter element according to claim 1;
a positioning device comprising a first engagement element extending in a radially outward direction, wherein the fold expansion at the inner wall surface of the filter medium body of the first ring filter element at least partially forms a first counter engagement element, and wherein the first engagement element of the positioning device engages the first counter engagement element.

13. The filter device according to claim 12, further comprising a support tube attached to the filter housing, wherein the support tube is releasably arranged in the interior of the filter medium body of the first ring filter element, and wherein the first engagement element of the positioning device is arranged at the support tube.

14. The filter device according to claim 13, wherein the ring filter element arrangement comprises a second ring filter element comprising a filter medium body, wherein the filter medium body of the second ring filter element is attached to the support tube radially outwardly.

15. The filter device according to claim 13, wherein the ring filter element arrangement comprises a second ring filter element arranged radially inside of the support tube and comprising at an outer wall surface thereof a second counter engagement element, wherein the positioning device comprises a second engagement element arranged at the support tube and extending in a radially inward direction, wherein the second engagement element of the positioning device engages in the radially inward direction the second counter engagement element of the second ring filter element, and wherein the first engagement element of the positioning device engages in the radially outward direction the first counter engagement element of the first ring filter element.

16. The filter device according to claim 12, wherein the ring filter element arrangement further comprises a second ring filter element comprising a filter medium body, wherein the filter medium body of the second ring filter element encloses an interior, wherein the first ring filter element at least partially is received in the interior of the filter medium body of the second ring filter element.

17. The filter device according to claim 16, wherein the filter housing comprises a housing positioning device configured to provide unequivocal relative angular positioning of the second ring filter element in relation to the filter housing, wherein the housing positioning device comprises a housing engagement element extending radially inwardly and wherein the second ring filter element comprises a corresponding housing counter engagement element, wherein the housing engagement element engages the corresponding housing counter engagement element.

18. The filter device according to claim 16, wherein the second ring filter element comprises a fluid-permeable inner tube arranged at an inner wall surface of the filter medium body of the second ring filter element and fastened to the filter medium body of the second ring filter element, and wherein the positioning device comprises a second engagement element arranged at the inner tube, and wherein the second engagement element extends radially inwardly and engages a second counter engagement element at an outer wall surface of the filter medium body of the first ring filter element.

19. The filter device according to claim 12, wherein the filter device is a cathode air filter configured to be used in a fuel cell.

20. A method of using a ring filter element according to claim 1 in a filter device, the method comprising:
providing an engagement element at a filter housing of the filter device;
arranging the ring filter element in the filter housing; and
the engagement element engaging the fold expansion of the ring filter element.
